(19) United States
(12) Patent Application Publication
(10) Pub. No.: US 2012/0215598 A1
(43) Pub. Date: Aug. 23, 2012

(54) Marketing and selling contributed resources in distributed computing

(75) Inventors: Nikolaos Georgis, San Diego, CA (US); Adrian Crisan, San Diego, CA (US); Milton M. Frazier, San Marcos, CA (US)

(73) Assignee: Sony Corporation, Tokyo (JP)

(21) Appl. No.: 12/929,838

(22) Filed: Feb. 18, 2011

(51) Int. Cl. G06Q 30/00

(52) U.S. Cl. 705/14.4

(57) ABSTRACT

A method or system for marketing and selling contributed resources of a plurality of separate electronic devices by generating a framework for resource contribution. The assigned contributed resources are the contributed resources that are assigned to credit categories. A credit category model is optimized based the assigned contributed resources using a dynamic availability of the assigned contributed resources and a processing requirement of a task. Resource contributions are tracked based on completed task segments, wherein the completed task segments are distributed task segments derived from the task that have been processed by the assigned contributed resources. And an account is credited based on the tracked resource contribution.

### BACKGROUND OF THE INVENTION

1. Field of the Invention

The application relates generally to a method for marketing and selling contributed resources of a plurality of separate electronic devices.

2. Description of the Related Art

Although group computing and collective rendering systems are currently in practice, their current employment is limited in a number of ways.

First, for example, the World Community Grid (WCG) gives personal computer owners the ability to donate their spare or idle personal computer into a contributory processing scheme, known as distributed computing, where their personal computer becomes part of an elaborate super-computer. Thus, the super-computer is not a central machine located in a development or research lab room; rather, it is the aggregation of computers that work as one super-computer processing a single task.

Unfortunately, however, computing across the WCG requires task initiation by the scientists who need to analyze data and run simulations and the user is simply a contributor who does not gain a benefit from connecting to an aggregate processing system. Further, the WCG requires users to actively sign-up to contribute, while not offering users a mechanism for forming and creating their own groups nor an appropriate method for requesting computation of a personal task.

### SUMMARY OF THE INVENTION

The present invention relates to a method or system for marketing and selling contributed resources of a plurality of separate electronic devices, comprising: generating a framework for resource contribution, wherein assigned contributed resources are the contributed resources that are assigned to credit categories; optimizing a credit category model based the assigned contributed resources using a dynamic availability of the assigned contributed resources and a processing requirement of a task; tracking resource contribution based on completed task segments, wherein the completed task segments are distributed task segments derived from the task that have been processed by the assigned contributed resources; and crediting an account based on the tracked resource contribution.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a flow chart illustrating a process for generating a model, optimizing a model, tracking resource contributions, and crediting user accounts.

FIG. 2 is a flow chart illustrating a process for generating a framework.

FIG. 3 is a flow chart illustrating a process for generating a model, running a simulation, optimizing a model, and checking a task queue.

FIG. 4a is a flow chart illustrating a process for detecting and modeling resources.

FIG. 4b is a flow chart illustrating a process for calculating device component availability.

FIG. 5 is a flow chart illustrating a process for task segmentation, task segment distribution, and redistributing incomplete task segments.

FIG. 6 is a block diagram illustrating a device for marketing and selling contributed resources.

FIG. 7 is a schematic diagram of a system for marketing and selling contributed resources.

FIG. 8 is a display diagram indicating a device's resource use.

FIG. 9 is a display diagram indicating the time to render a frame.

FIGS. 10a-10c are graphs illustrating CPU status over time.

### DETAILED DESCRIPTION OF THE INVENTION

In the following description, for purposes of explanation, numerous details are set forth, such as flowcharts and system configurations, to provide an understanding of one or more embodiments of the present invention. However, it is and will be apparent to one skilled in the art that these specific details are not required to practice the present invention.

The present invention relates to a method for marketing and selling contributed resources of a plurality of separate electronic devices, comprising: generating a framework for resource contribution, wherein assigned contributed resources are the contributed resources that are assigned to credit categories; optimizing a credit category model based the assigned contributed resources using a dynamic availability of the assigned contributed resources and a processing requirement of a task; tracking resource contribution based on completed task segments, wherein the completed task segments are distributed task segments derived from the task that have been processed by the assigned contributed resources; and crediting an account based on the tracked resource contribution.

An electronic device may be constituted of program code, which is stored on a computer-readable medium, that is executed by the central processing unit (CPU) to provide the operations described above or herein; however, it may alternatively comprise of hardware, firmware, or combinations of software, hardware, and firmware. For example, the electronic device constituted of program code may generate a virtual machine, a system virtual machine, or a process virtual machine. Further, for example, the electronic device comprising of hardware, firmware, or combinations of software, hardware, and firmware may be a computer that contains the internal components of a read only memory (ROM), random access memory (RAM), graphics processor, CPU, network interface card, etc. However, the electronic device is not limited to the above described computer. Other examples include a personal computer, a mobile phone, a hand-held device, a laptop personal computer, a digital clock, a digital watch, a global positioning system device, a scanner, a printer, a home theatre system, a gaming machine, an electronic desk phone, a vehicle stereo, a vehicle's management computer, an handheld music player, a dishwasher, a microwave, a security system, a camera, a camcorder, or any other electronic device that has at least a processor and interface. Thus, the electronic device may be constituted of program code; a modest electronic device, such as a processor and interface; a complex electronic device, such as a high-tech supercomputer with multiple processors and multiple interfaces; or various other electronic devices that comprise combinations of program code, software, hardware, and firmware.

The processor, as described above, may be any processing unit that calculates, computes, or counts signals received from an interface or that outputs a computation or calculation result to an interface, such as CPU, graphics processor, multiplexer, decoder, shift-register, or various other processors

The interface, as described above, may be any communication technology that allows a processor to receive or send data, such as a Graphic User Interface (GUI); a virtual interface; an application programming interface (API); a touch screen; a sensor; a keypad; a keyboard; a network interface for a IP WAN/LAN network, WiFi network, Bluetooth, 3G wireless, 4G wireless, an IR interface, satellite, microwaves; or various other interfaces.

Generating the framework for resource contribution may comprise of providing an interface for retrieving resources of the separate electronic devices; setting default credit categories for the retrieving resources and default account credits; and providing a user interface for altering default credit categories and account credits.

Also, the above mentioned interface for retrieving resources may be provided by one of an email; a pre-installed application on a separate electronic device; a web-interface; and a smartphone application. Similarly, the above mentioned user interface for altering default credit categories and default account credits may be provided by one of an email; a pre-installed application on a separate electronic device; a web-interface; and a smartphone application.

Further, the contributed resources associated with incomplete segments may be excluded from credit category assignment.

In addition, optimizing the credit category model may further comprise of generating the credit category model based on the assigned contributed resources in a credit category; simulating an assessment task to determine an assessment computation time according to the credit category model; and updating the credit category model to optimize a task computation time based on the dynamic availability of the assigned contributed resources and the assessment computation time.

Further, simulating an assessment task may maximize a total processing power of the credit category model.

Furthermore, the dynamic availability of the assigned contributed resources may change over time respective to a number of separate electronic devices connected and in use and respective to a transfer speed and connection medium of a communication type.

In addition, processing distributed task segments may comprise of distributing task segments of the task for processing based on the optimized credit category model; and dynamically redistributing incomplete segments of the task for processing by further updating the optimized credit category model based on the dynamic availability of the resources.

Further, each incomplete segment may be a task segment that has not been received within an estimated processing time, and the estimated processing time may be the result of calculations completed during optimizing the credit category model.

Furthermore, dynamically redistributing incomplete segments may comprise of distributing an interpolation task that interpolates the incomplete segments based on relative completed task segments.

Also, tracking resource contribution may be implemented using communication protocols or based on the completed task segments.

In addition, credit categories may comprise of one or more of a multimedia category; a user category; a donation category; an application category; and a resources wholesale category. Crediting an account may comprises of one or more of providing free resource availability; providing proportional resource availability; providing free or discounted movie tickets; providing points for online purchase credit; providing tax write-offs; and providing application access.

Moreover, the contributed resources a separate electronic device of a plurality of separate electronic devices may comprise of one or more of a set of processors, a set of memories, and a set of communication types.

The above described system, which generally operates as a grid computing system, may fit well in an enterprises environment where general consumers may contribute their computing power to the grid. Thus, the system may allow electronic device owners to permit third-party systems to utilize their idle processing power, and the third-party systems may compensate the owners proportionally for the donated computing power. Further, owners may be able to sell their resources to a third party, donate their resources to a charity, wholesale storage resources to a third party, or all of the above.

To encourage those owners and users who may not be contributing to the systems, the system may offer incentives, such as movie tickets, points to buy online movies, or tax write-offs for charitable processor donation.

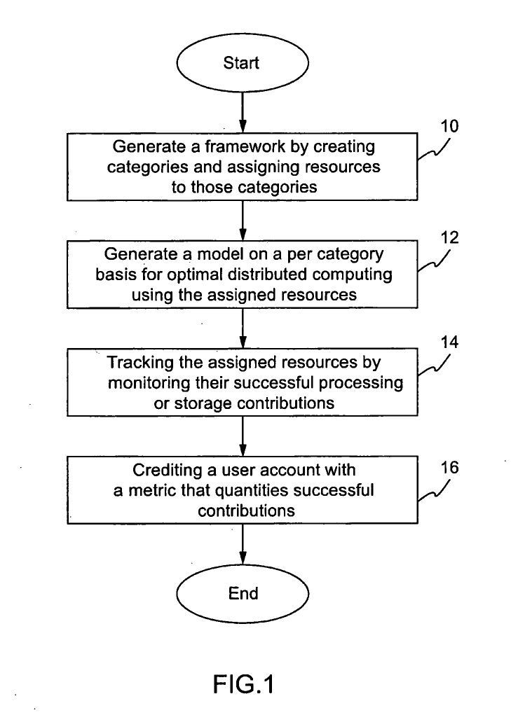

FIG. 1 is a flow chart illustrating a process for generating a model, optimizing a model, tracking resource contributions, and crediting user accounts. In FIG. 1, a system generates 10 a framework by creating categories and assigning resources to those categories. Then, a system generates 12 a model per category using the assigned resources for optimal distribution and computing of a task. Next, the system tracks 14 the assigned resources by monitoring their successful processing or storage contributions. Then, the system credits 16 a user account using a metric that quantifies the users successful resource contributions that were tracked 14.

When generating 10 a framework by creating categories a system may use a default category set. The default category set may be pre designated credit categories, for instance, a vendor category; a multimedia category; a user category; a donation category; an application category; and a resources wholesale category. Further, the default category set may be altered to include more or less categories.

When generating 10 a framework by assigning resources a system may use default assignments. For instance, the default multimedia category may be for transcoding movies, and a graphics processor resource may be automatically assigned to the multimedia category.

In addition, projects may render a category. For instance, Save Humanity, which is a charitable organization, may be a sub-category under the default donation category or the VAIO Super App World may be a sub category under the default application category.

With the framework generated 10, the system generates 12 a model per category for optimal task segment distribution and task processing using the assigned resources. The system constructs each model using statistical techniques. The model renders an estimated processing time for a given common task related to the category. The estimated processing time should be faster than a task's actual processing requirement, and a task's actual processing requirement may be based on simulation results or a task that is in the system's queue or in a category history.

Next, the system tracks 14 the assigned resources by monitoring their successful processing or storage contributions. Tracking 14 the assigned resources by their successful processing or storage contributions provides the system with a real time method for assessing the system's weak points, notifying users of whether their contributed resources are stable, and informing third parties of whether they are receiving a guaranteed benefit. The guaranteed benefit may be a processing or storage amount that a third party is contracting for.

Then, the system credits 16 a user account using a metric that quantifies the user's successful resource contributions that were tracked 14. That is, because a system tracks the completed jobs by a resource and because resources are allocated to a category prior to receiving a job from the system, the system may credit a user account, and the respective category, when a resource successfully performs a job assigned by the system. In other words, the systems may credit or debit accounts based on the tracked information. In addition, successful segment storage should be tracked.

For example, a user contributes their laptop to a system. The framework slots the laptop's graphics processor into the default multimedia category. The laptop's graphics processor is now a portion of the multimedia category's processing power. The system then generates a model that encompasses the newly added graphics processor and simulates transcoding a movie across the model. Next, a request for transcoding a movie arrives in the system queue. The system segments the transcoding task and sends some of the segments to the laptop's graphics processor. The system tracks whether the laptop's graphics processor successfully transcodes the segments, and if the laptop's graphics processor does successfully transcode the segments then the system credits the user account proportionally. The user may receive credits or points towards future personal transcoding tasks, for instance, a user may utilize the transcoding credit to purchase processing power from the grid to transcode their own movie. Thus, as a user adds resources to the system, they may later have proportional access to system resources.

Therefore, users who regularly contribute resources that successfully complete system jobs will receive credits towards their contribution. Contrarily, because the system tracks successful jobs, the system tracks when a resource fails to complete an assigned task and accordingly, does not receive credit a user account. Thus, incentives exist for users to contribute resources, regardless of how minimal that resource is, providing that resource can complete distributed tasks.

Other incentives, outside of the transcoding credit mentioned above, are movie tickets or points for buying movies. Similarly, if a user donated their resources to the donation category, the user may earn tax write-offs for the charitable resource donation. In general, crediting an account may comprises assigned a point structure so that a user has access to free or proportional resource availability; to free or discounted movie tickets; to points for online purchase credit; to tax write-offs; or to application access. Further, because the resources are assigned to a category, users may be able to join together and sell their resources to a third party collective, donate their resources to a charity collectively, or wholesale storage resources to a third party collectively. In addition, a third party who is purchasing the wholesale resources may be reassured by the generated 12 model under their category that they are receiving the guaranteed benefit.

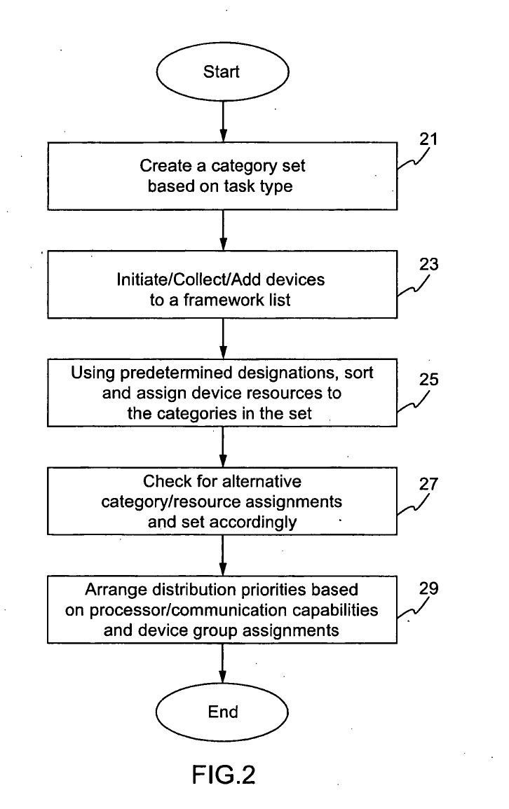

FIG. 2 is a flow chart illustrating a process for generating a framework. In FIG. 2, a system creates 21 a category set based on the task type. Then a system initiates 23, collects, or adds devices to a frame work list. Next, a system uses 25 predetermined designations to sort and assign device resources to the categories in the set. Then, a system checks 27 for alternate category/resources assignments and sets the new assignments accordingly. Next, a system arranges 29 distribution priorities based on processor/communication capabilities and device group assignments.

When a system creates 21 a category set based on the task type, the system tailors the framework based on user or company need. For instance, if a corporation needs processor space for calculating security searches then the system may construct a security category. Alternatively, if a user wants to render a 3D model of a building architecture using a third part application then the system may create a modeling category.

One a systems has created the category set, it may do one or all of the following: initiate 23 connections with the devices subscribing to the system, collect the device information such to add the device, add the devices to the framework based on the information collected. Thus, in this step a system seeks resources and gathers resource data in preparation for the next step.

Next, a system uses 25 predetermined designations to sort and assign device resources to the categories in the set. For instance, if a corporation needs processor space for calculating security searches then the system may construct a security category where a threshold permits of deny resources to contribute. Alternatively, if a user wants to render a 3D model of a building architecture using a third part application then the system may create a modeling category where only PCs with advance graphics cards may contribute.

Then, a system checks 27 for alternate category/resources assignments and sets the new assignments accordingly. Here, the systems is reconfiguring based on outside input, that is, non-default input. For instance, if a device based on its internal components is more suited for 3D rendering but a user has designated their PC for security calculations that then system would be forces to reallocate that specific PC to a new category.

Next, a system arranges 29 distribution priorities based on processor/communication capabilities and device group assignments. That is, once the resources are assigned to a category, whether based on default settings or configured settings, others factors may play a role in the distribution of task segments. Using the collected 23 data, such as the network connection speed and processor speeds, regarding multiple devices a system may set priorities based on the faster connections or, alternatively, reliability of the connection or other rubric.

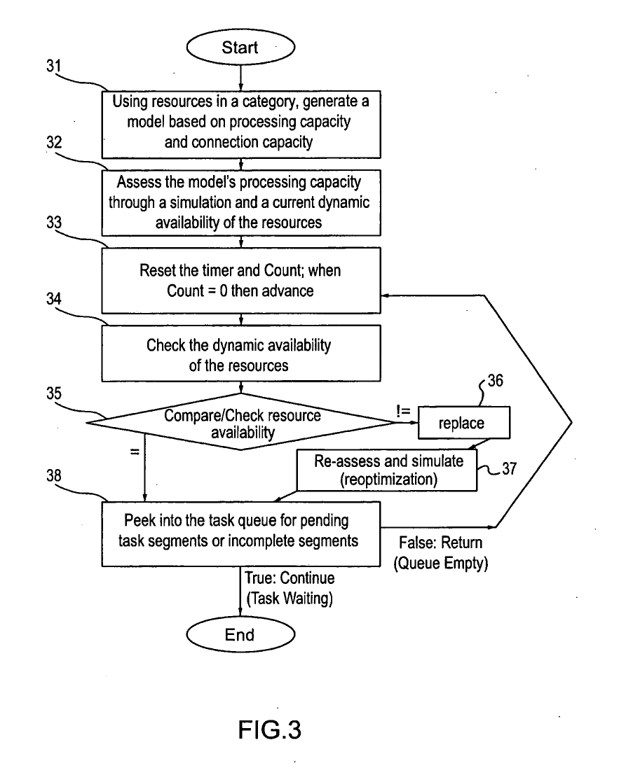

FIG. 3 is a flow chart illustrating a process for generating a model, running a simulation, optimizing a model, and checking a task queue. In FIG. 3, a system uses the resources in a category to generate 31 a model based on the processing and connection capacity. Next, the system assesses 32 the model and the total processing capacity through a simulation and integrating the current dynamic availability of the resources. Then, a timer is set or reset 33 to a time limit and counting begins. After the timer is finished, the dynamic availability of the resources are checked 34. Next, the resource data before the timer step is compared 35 to the dynamically available resources 34. If the comparison shows that the resource data is not equal then the system replaces 36 the old resource data with the newly acquired dynamically available data re-assesses 37 and re-simulates the model with the newly acquired dynamically available data. After re-assessing, the system peeks 38 into the task queue to check for a pending task or task segment. If the comparison shows that the resource data is equal then the system immediately peeks 38 into the task queue. The task queue may operates as a true/false function, in addition to a queue, where when the queue has a task waiting the optimization of the system ends and segmentation of the task and distribution of the task segments begins. If the queue is empty, that is there is no task waiting, the system returns to the timer stage, resets 33 the times, and counters.

In general, FIG. 3 is a process for optimizing. The system utilizes the model to calculate the optimal distribution for the fastest task processing, which should be sufficiently below a task's processing requirement. A task's processing requirement may be based on a task that is in the system's waiting to be processed queue, on a task history, or on the results generated from the simulation.

Optimization may more specifically operate as follows: when generated 31 a model and assessing 32 the model's resources, a first variable may be assigned to a specific component within an electronic device or the device itself. That first variable may be set to a value equal to the idle time or to a value that indicates the dynamic availability of that component or device. Variable setting may be repeated for each component per device in a system, for each device in a system, or for any desired level of optimization granularity and is not limited to a single component.

Next, a timer is set and started 33. The timer or counter regulates how often the system checks, whether individually or collectively, the components, devices, or system. When the timer finishes, a component's or device's current idle time or dynamic availability is checked 34 and set to a second variable.

The first and second variables may then be compared 35. When the first and second variables are equal the system checks 38 a task flag. If the task flag is false, which means there are no tasks waiting to be distributed in the system, then the system resets the timer and counts again. Thus, the system may wait for a task while constantly checking the dynamic availability of the components and devices within the system. Similarly, if a task is in a queue the system may wait for an appropriate amount of resources before distributing. However, if the task flag is true then the system may end its dynamic optimization, and distribute task segments based on the current optimized model, whether generated from the first optimization 32 or from an earlier re-optimization 37.

When the first and second variables are not equal the second variable's value may replace 36 the first variable's value and the system may proceed to a second optimization 37. After re-optimization 37, the task flag is checked 38 and, as described above, the system may continue to monitor the model or end this sub-routine.

In addition, the system is not limited to optimization before distribution and after modeling, and other embodiments may include an optimization simultaneous with distributing, modeling, or re-optimization.

Also, optimization may dynamically and constantly cycle so the system and the task processing model are always active and updated, and, as such, when a task request is received the system may proactively know whether the task segments can be immediately distributed.

Further, it may be advantageous if the model were re-optimized after the first distribution of task segments, as the component availability would change once the component receives a task segment. Furthermore, optimization may also generate a task segment predictability variable or timing variable. Since a system constantly optimizes a shared computing platform the system can predict an estimated time or a completion delay for a task segment's processing.

For example, a system may detect two laptops A and B that are equal electronic devices with equal system connections and the system may update a model based on this detection for equal distribution. Further, if a user begins an activity, such as web browsing, on laptop A, then the available resources for laptop A will decrease. When this decrease is detected (i.e. comparing 35 the past variable with current variable) the system may optimize 37 again.

In another optimizing example, when laptop A, which contains a state-of-the-art processor and connects to the system via a 56k Modem, and laptop B, which contains a mid-level processor that is relatively slower than the state-of-the-art processor and connects to the system via a 1 GIG NIC, are detected by the system, the system may recognize the bottlenecks per device and statistically optimize the model for distributing tasks. Thus, although the laptop A processor is faster than laptop B the network connections for both Laptops will contribute proportionally to the optimization.

Optimization may be any number of statistical techniques for finding the shortest processing time of a task, such as regression or standard deviation, and these techniques may be used interchangeably, collectively, in isolation, or in any similar manner. The frequency of optimization may also be toggled or adjusted, for instance, the timer may be set to a low number thereby increasing the number of variable checks and model optimizations.

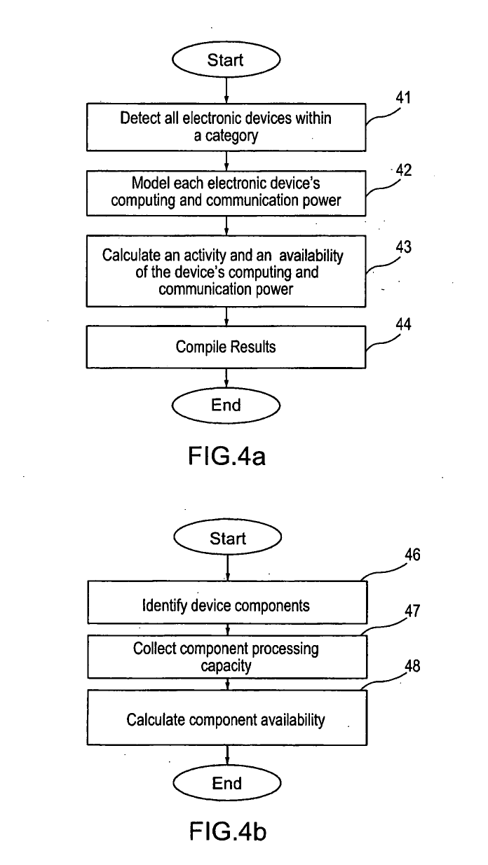

FIG. 4a is a flow chart illustrating a process for detecting and modeling resources. Specifically, FIG. 4a, is a further description of a system generating 31 a model based on the processing and connection capacity and assesses 32 the model and the total processing capacity through a simulation and integrating the current dynamic availability of the resources.

In FIG. 4a, the system detects 41 all electronic devices within a category, then models 42 each electronic device's computing power. Next, the system calculates 43 the activity and availability of the devices computing power and communication power. This process concludes when the results are compiled 44.

To calculate the resources within a framework, as indicated in FIG. 4a, a system detects 41 the electronic devices within a selected category. Category assignment may be based on the description above or any number of assignment algorithms, contact lists, or social networking groups whether combined or taken individually. Detection 41 may be a handshaking where one device verifies that another is connected within the selected group. For example, detecting 41 an electronic device may be achieved by a system seeking selected group members through an echo request, such as ping, or a MAC address look-up. Detection 41 is not limited to these mechanisms and may be carried out by any number or combination of detection mechanisms.

After detection 41, the components and connections of the detected electronic devices are modeled 42. Modeling 42, preferably, “traces” the capabilities of the detected electronic devices, regardless of the device type.

For example, a laptop personal computer (laptop) is detected 41 by first receiving a ping to verify a connection and, once the connection is verified, a modeling 42 or diagnostics test reveals the laptop's internal components of a read only memory (ROM), random access memory (RAM), graphics processor, central processing unit (CPU), network interface card, etc.

Next, a process calculates 43 the activity and availability of the devices' computing and communication power. In other words, each electronic device may not be ready to contribute its full resources to the system. Each electronic device may be running subroutines, browsing the web, playing a movie, or processing other tasks that require resources. Therefore, the electronic device may only have a portion or percentage of availability for its components and connections.

For instance, a laptop may only be running a virus scan wherein 10% of the CPU's processing power is being used. Thus, the network interface and graphics card are fully available to donate. Further, a laptop may also be streaming a movie from an online source. Thus, the graphics card may not available and the processor may be limited to a 90% donation.

Further, the results of calculating 43 the activity and availability of the devices computing and communication power are compiled 44. Compiling 44 presents a data set for updating or optimizing a model for task distribution and repeating a simulation over the updated model. For example, simulating an assessment task may assume maximization of a total processing power of the modeled resources of a plurality of separate electronic devices, such that a time estimate is rendered for the case where all resources are in use. This simulation on an updated model may generate a result set that may indicate that the processing time for a live task, which does not maximize a total processing power, may be less than the simulation estimate. In addition, simulation may be performed locally (that is statistically calculated on the distributing electronic device) or across the system using a test task and the modeled data.

FIG. 4b is a flow chart illustrating a process for calculation of device component availability. The process includes identifying 46 the specific components within a laptop. When identifying components the system may tag or label these components for a specific task type. Further, a system may use the identifying 46 portion of the process to compare components past performance and give a rating or ranking based on that performance. For instance, a graphics processor may be more suited for picture annotation while a CPU may be designated for algorithms. These identifying constraints may be based on the level of control the system should have in distributing. Furthermore, the process includes collecting 47 the total processing capacity for each component and calculating 48 the idle percentage of the component by utilizing a component's total processing capacity. Similarly to identifying 46, collecting 47, and calculating 48 may contribute to component labeling.

With the model built and the simulation complete a system may use a result set for updating the model using the dynamic availability of the resources and a task's processing requirement. A “second tracing” is conducted, where the resources of an electronic device, i.e., a set of processors, a set of memory modules, and communication types, are inspected for activity. The second tracing reveals the dynamic availability, which is the current status of a component or device. The dynamic availability of a resource often will change over time. The processors, memory modules, and communication types may receive different tasks from different sources. It is important to account for these changes to render the optimal processing time.

The system may constantly monitor and optimize the model based on activity within the system while waiting for a task request to render an optimal processing time for any given task. Further, the system may, after an initial model is complete, utilize the initial model and activity within the system for statistical optimization. Optimizing and updating may be used interchangeably when refereeing to adjusting the model in real time.

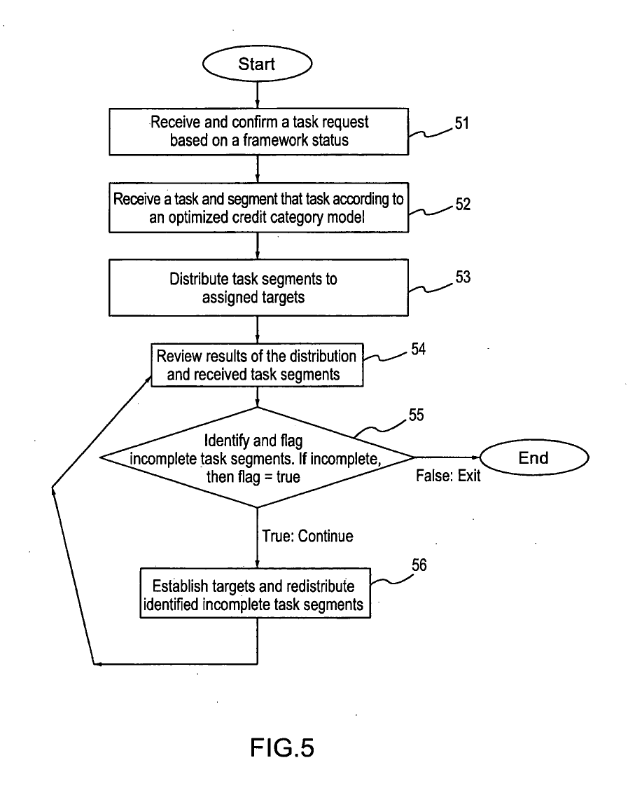

FIG. 5 is a flow chart illustrating a process for task segmentation. In FIG, 5, a system receives 51 and confirms a task request based on the framework status. Next, the system receives 52 tasks and segments those tasks according to the optimized credit category model. Then the system distributes 53 the task segments to the assigned targets. Next, the systems reviews 54 the results of the distributed and received task segments. Then the system identifies 55 and flags incomplete task segments, that is, if there is an incomplete task segment then alter the incomplete segment flag to true. If the flag is true then the subroutine continues by establishing 56 targets and redistributing the identified incomplete task segments. If the flag is false because there were no incomplete segments identified then this subroutine may end.

Thus, the system receives 51 a task request and confirms the task request based on resource availability. The system may verify a threshold percentage of available resources, such that if the system does not have available resources then the system may deny the request to process a task. Alternatively, the system may confirm the receipt of a task request but deny processing until further resources are available, or the system may add the task request to a task request queue. The queue may be a first in first out queue or other alternatives, such as a last in first out stack. Also, the validation of resources may be based on the model or optimized model.

After receipt and confirmation 51 of a task request, a task is received 52 and segmented into task segments. During segmentation, the system establishes target connections and device resources for each segment based on an optimized model. When the model proactively optimized the system may more quickly distribute or submit 53 the task segments to their assign targets. Further, the system may and estimate a completion time based on the model (or optimized model) and assigned targets.

The system may review 54 a result set and its relative flags 55 for incomplete data, corrupted data, or missing data. If an incomplete segment is found through checking 55 the error flags (meaning the error flag is true) then the system may redistribute or submit 56 the incomplete task segment for re-processing. If the error flag is false then the system may exit. After resubmission, the system must again wait to compile a processed task.

Alternatively, a system may reorder remaining task segments with any identified incomplete segments and redistributing the remaining task segments according to the reordering. In addition, the system may re-optimize before redistribution to maximize the processing time for the remaining unprocessed data.

A system may, also, not redistribute the task segments. Rather, a system may interpolate the incomplete segments based on relative task segments. Further, the interpolation may be distributed amongst the dynamically available resources based on a model or optimized model.

Further, a system may identify incomplete segments by compiling received task segments rather than checking status flags, such that a system is compiling received task segments simultaneous with dynamically redistributing incomplete segments, as those incomplete segments are identified through the compiling. More specifically, a task segment that cannot be compiled do to segment corruption may be revealed only during compiling.

Alternatively, re-optimization may show that a resource is now unavailable. For instance, if a resource is processing a task segment and through updated the model a system detects that that resource is no longer connected or has failed in some other way, the system may assume that task segment may not be completed and may redistribute or interpolate that segment. Similarly to not receiving a processed segment within a designated processing time, if a component or electronic device is offline for a length of time the system may designate that component or electronic device as unavailable. In other words, the incomplete task segments may be designated incomplete when a task segment has not been received within a processing time that was estimated during optimization, when a device or component goes offline for a designated length of time, or by other similar means. In addition, the dynamically available resources associated with incomplete segments may be excluded from re-optimization, as a system may not want to redistribute task segments to a device that frequently fails to perform without errors.

Also, the system may wait to compile the returned processed task segments. The system may use a timer to count for the length of time equal to the estimated processing time for a task segment or may check a task segment receipt flag. If the task segment receipt flag is true then the task segment has been received and the system may proceed to compiling. If the task segment receipt flag is false then the task segment has not been received. The system may wait longer or exit the subroutine.

Thus, in the aggregate, a system may wait for a set of process task segments i, check the relative task segment receipt flag RFi, and after either all the processed task segments were received or exit functions performed compile the sum Σ of processed task segments i where the segment receipt flag is true (RFi=1).

Regardless, it may be necessary to receive and compile each task segment to completely process a task and when the system has missing or incomplete segment the system may redistribute 56 the incomplete task segments after a model is further updated. It may be preferred that the system dynamically redistributes incomplete segments, such that as the system identifies an incomplete segment it immediately redistributes them.

In addition, layers of security and compression may be added to some or all transfers. For instance, encryption algorithms may be performed on task segments and completed segments. Further, the selection of resources in a category (or even creation of categories) may be based on secured connections, access levels, or a member's encryptions capabilities. Furthermore, the system may select the task segment distribution based on the task demands for security and resources available.

Descriptions of embodiments of marketing and selling contributed resource are below.

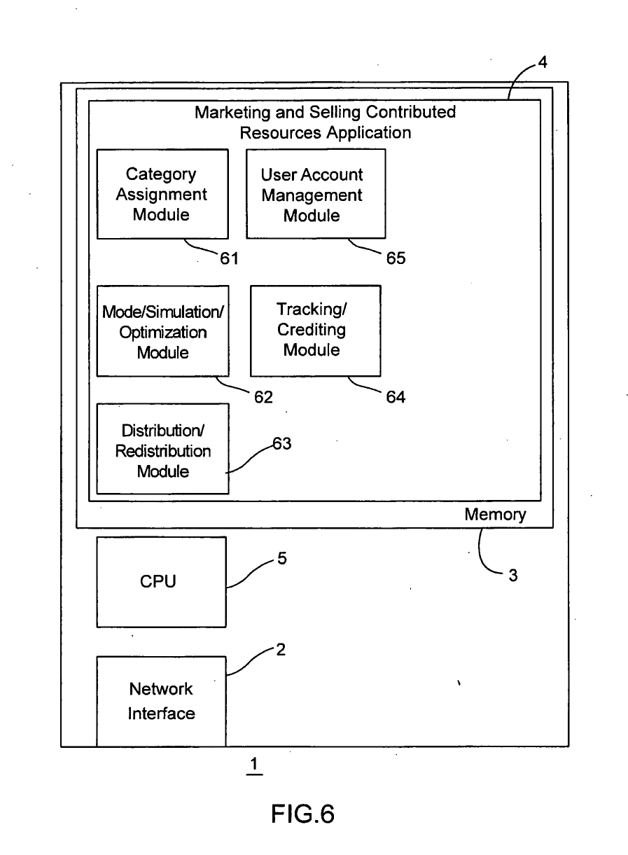

FIG. 6 is a block diagram illustrating a device for marketing and selling contributed resources. The electronic device 1 has a memory 3, a network interface 2, and a processor (CPU) 5. The memory 3 further has a marketing and selling contributed resources application 4 that contains a category assignment module 61, model/simulation/optimization module 62, a distribution/redistribution module 63, a tracking/crediting module 64, and a user account management module 65.

The marketing and selling contributed resources application 4 is preferably constituted of program code executed by the CPU 5 to provide the operations described herein; however, it may alternatively comprise of hardware, firmware, or combinations of software, hardware, and firmware.

The model/simulation/optimization module 62 is configured to generate a model based on resources of a plurality of separate electronic devices, to simulate an assessment task to determine a computation time for the assessment task according to the model, to update the model to optimize the computation time based on a dynamic availability of the resources and a processing requirement of a task.

The redistribution/distribution module 63 is configured to distribute task segments for processing the live task based on the updated model. The redistribution/distribution module 63 is configured to dynamically redistribute incomplete segments for processing the task by further updating the model based on the dynamic availability of the resources.

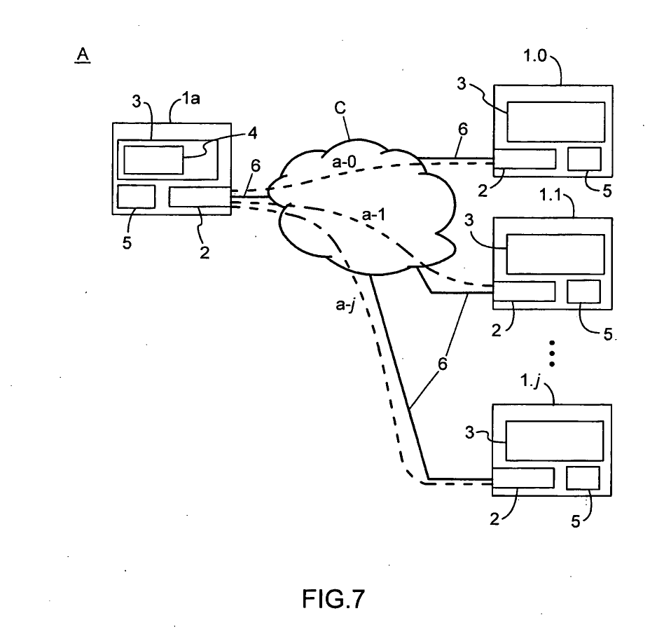

In addition, the system may be a server system that optimizes a client framework. FIG. 7 is a schematic diagram of a system for marketing and selling contributed resources. In FIG. 7, a system A has an electronic device 1a that has a memory 3, a network interface 2, and a processor 5. The memory may contain any of the combination of modules described above, such as a marketing and selling contributed resources application 4. The electronic device 1a has a physical connection 6 to a cloud C that permits virtual connections a-0, a-1, and a-j to electronic devices 1.0, 1.1, and 1j, respectively (where j is an integer representing the total number of electronic devices connected to the system). Each electronic device 1.0-1.j has a network interface 2 that has a physical connection 6 to the cloud C, resources 3, and processor 5.

For example, in the server embodiment a laptop, such as a Sony Vaio laptop, may be the server. The Vaio server a may host the Vaio distributed application and manage the clients 1.0-1.j by using its marketing and selling contributed resources application 4. Further, the Vaio server 1a may model the network by using a bandwidth estimator to minimize the time on network, by pinging for response times, and by modeling the available processors in a simulation to collect the statistics. Thus, a model is dynamically updated by a Vaio server 1a in a Vaio exclusive cloud C.

Once the model is built, a Vaio server la may distribute task segments across the cloud C based on the processing power demanded by a task and the connection speeds, security access, or even licensing and tracking described the model. Also, the clients 1.0-1.j may subscribe to multiple systems, networks, or groups. Further, the Vaio server corrects incomplete segments based on the available models and resources.

Also, in the above system, a CPU Multiplier, which is like a blade computer in an enterprise environment, may be added. CPU multipliers have no hard drive and comprise manly of processing power with a network interface. Thus, any module, for example the monitoring and optimization module, within the system could be supplemented by adding a multiplier.

Similarly, old and new electronic products may be added to the system. For example, an old computer would not necessarily need to be upgraded. It could be added to the system, have access to the aggregate processing power on the network, and be able to distribute, offload, or share a task. And the old computer does not have to be homogeneous with other electronic devices within the system. The old computer could be any different form factor, i.e. Linux, Linux embedded, Windows, etc., or contain any component brand, i.e. AMD or Intel. Further, other electronic devices not typically associated with shared computing, such as TVs, DVRs, etc., may be added. Thus, the present invention allows for a system to connect to devices within a home; describe the cumulative idle time; resource type, i.e. graphics processor, central processor, or any other type of processor know in the art; and distribute task segments to all available devices.

Regarding the type of task for shared processing, a system may compute any task. However, the advantages of the above described system are the super-computing and incomplete segment correction abilities. Thus, complex image generation, large scale sampling computation, transcoding, etc. are examples of said task types. For example, a task may be computing a complex algorithm where the segments are individual calculations in the complex algorithm; transcoding a movie where the task segments are individual time segments of the movie; rendering a 3D movie where the task segments are individual pixels segments in a frame of the 3D movie; or annotating an electronic photo album where the segments are individual photos of the electronic photo album.

Further, for example, if an individual Laptop receives a task to transcode a movie, for instance a movie from a camcorder, so that the Laptop may upload the movie to a webpage, such as YouTube.com, the Laptop may take seven hours to transcode one frame of a movie. However, when the above system receives a task request to transcode a movie, the above system may transcode the movie in real time while uploading the movie to YouTube.com, such that for every Laptop within the system a frame may be rendered simultaneously.

Furthermore, if there are two Laptops then the total number of frames is divided by two. Furthermore, for X number of Laptops the total number of frames is divided by X. Thus, if a system has only one Laptop that computes one frame per seven hours then a movie with a million frames would take years to transcode. However, if the system has half a million Laptops with similar capabilities then the movie could be transcoded in roughly fourteen hours plus other processing overhead. In addition, error possibilities may increase with the increase in complexity of a system. Therefore, the above system's task segment redistribution and task interpolation techniques may be implemented. Thus, if connections drop, devices error, or other failures occur the movie may and can still be rendered.

Similarly, a high-resolution image may take 30 minutes for a LAPTOP to render. However, a because the image may be divided and distributed among the available processors such that each separate processor renders a different portion of the photograph (as in a pixel or a set of pixels) the system may reduce the rendering time by a factor of the number of electronic devices connected to the systems.

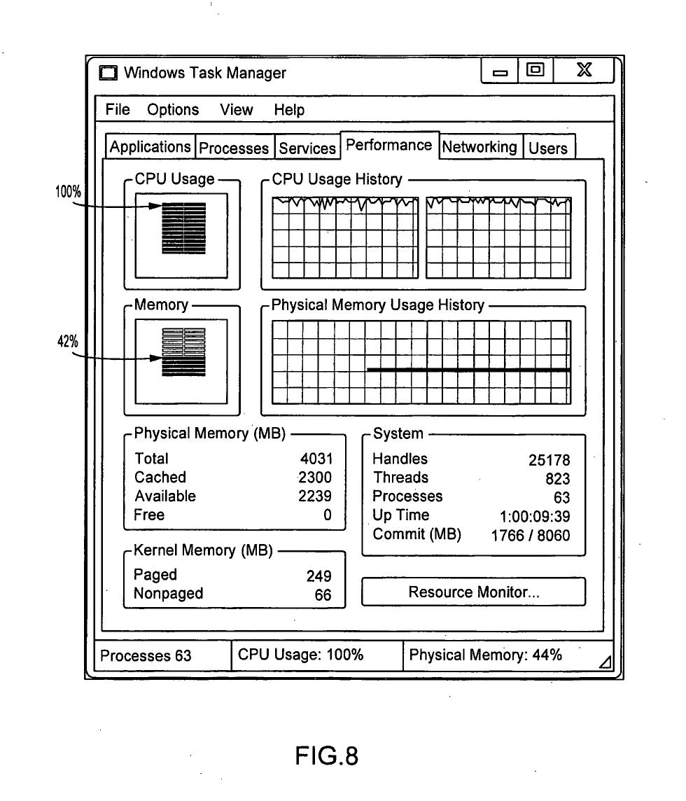

FIGS. 8, 9, and 10a-10b are demonstrations of a system transcoding a movie 20 to 40 times faster than if one PC were to transcode the same movie independently. FIG. 8 is a display diagram indicating a device's resource use. In FIG. 8, the PC's CPU usage is at 100%. If this usage is a PC usage then the CPU is not available as a resource for the system because the CPU is at full capacity. However, the physical memory is only at 42%. Thus, the physical memory is 68% idle and is still an available resource for the system. The system may contain a threshold availability for a component where the system may never use a component if its current use is more than a designated amount, such as 50%. If the threshold is met then the system may label that component as an unavailable resource. Thus, if a 50% threshold for the components in FIG. 8 is used then the physical memory is available while the CPU is unavailable.

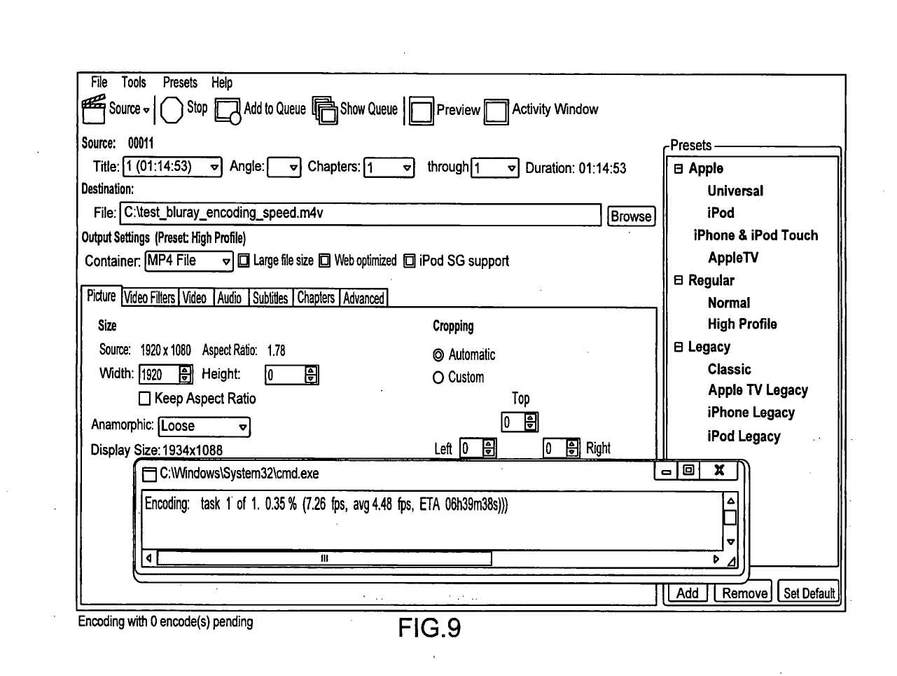

FIG. 9 is a display diagram indicating the time to render a frame. In FIG. 9, the PC in the system is estimating the remaining time to complete a distributed task of transcoding a frame (i.e. ETA 06h39m38s). Further, if the frame was divided into segments, such as four quadrants, and this PC was designated to process only one of those segments, i.e. one quadrant, then the amount of time for this PC to finish transcoded would be divided by the number of segments, i.e. 6 h 40 m/4=1 h 40 m.

Alternative embodiments of the system described above may take many forms where the steps are performed simultaneously, are isolated, or are ordered differently. Further, the systems may also be embodied in hardware.

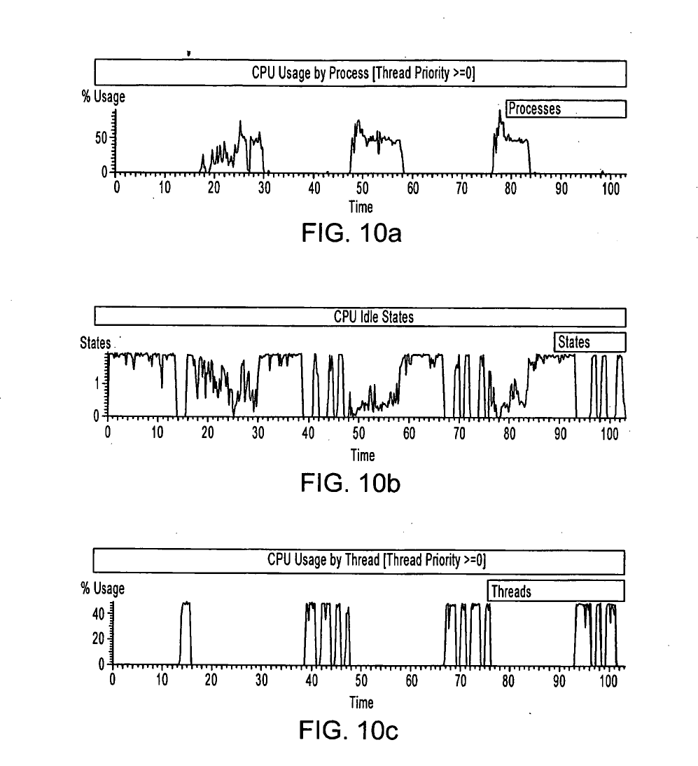

FIGS. 10a-10c are graphs illustrating CPU status over time. FIG. 10a is the CPU usage by a PC over time; FIG. 10b is the CPU idle state over time; and FIG. 10C is the CPU usage by the systems over time. When comparing FIGS. 10a to 10b and 10c to 10b it is noted that the idle state is low when the CPU usage is active. Similarly, when comparing FIGS. 10a and 10c the CPU usage by the system is independent of the CPU usage by the PC. Also, when comparing these figures it is noted that after the CPU has been in an idle state for a specific period of time, i.e. 9 increments, the CPU usage by the system goes high; however when the CPU usage by the PC begins the CPU usage by the system immediately stops. These relationships are clearly demonstrated by the four sets of peaks in FIG. 10c and the three sets of peaks in FIG. 10a.

Thus, embodiments of the present invention produce and provide a system for marketing and selling contributed resources. Although the present invention has been described in considerable detail with reference to certain embodiments, the invention may be variously embodied without departing from the spirit or scope of the invention. Therefore, the following claims should not be limited to the description of the embodiments contained herein in any way.

1. A method for marketing and selling contributed resources of a plurality of separate electronic devices, comprising:
generating a framework for resource contribution, wherein assigned contributed resources are the contributed resources that are assigned to credit categories;
optimizing a credit category model based the assigned contributed resources using a dynamic availability of the assigned contributed resources and a processing requirement of a task;
tracking resource contribution based on completed task segments, wherein the completed task segments are distributed task segments derived from the task that have been processed by the assigned contributed resources; and
crediting an account based on the tracked resource contribution.

2. The method of claim 1, wherein generating the framework for resource contribution, comprises:
providing an interface for retrieving resources of the separate electronic devices;
setting default credit categories for the retrieving resources and default account credits; and
providing a user interface for altering default credit categories and account credits.

3. The method of claim 2, wherein one of an email; a pre-installed application one a separate electronic device; a web-interface; and a smartphone application provides the interface for retrieving resources.

4. The method of claim 2, wherein on of an email; a pre-installed application one a separate electronic device; a web-interface; and a smartphone application provides the user interface for altering default credit categories and default account credits.

5. The method of claim 2, wherein contributed resources associated with incomplete segments are excluded from credit category assignment.

6. The method of claim 1, wherein optimizing the credit category model, comprises:
generating the credit category model based on the assigned contributed resources in a credit category;
simulating an assessment task to determine an assessment computation time according to the credit category model; and
updating the credit category model to optimize a task computation time based on the dynamic availability of the assigned contributed resources and the assessment computation time.

7. The method of claim 6, wherein simulating an assessment task maximizes a total processing power of the credit category model.

8. The method of claim 6, wherein the dynamic availability of the assigned contributed resources changes over time respective to a number of separate electronic devices connected and in use and respective to a transfer speed and connection medium of a communication type.

9. The method of claim 1, wherein processing distributed task segments, comprises;
distributing task segments of the task for processing based on the optimized credit category model; and
dynamically redistributing incomplete segments of the task for processing by further updating the optimized credit category model based on the dynamic availability of the resources.

10. The method of claim 9, wherein each incomplete segment is a task segment that has not been received within an estimated processing time, and
wherein the estimated processing time is the result of calculations completed during optimizing the credit category model.

11. The method of claim 9, dynamically redistributing incomplete segments comprises distributing an interpolation task that interpolates the incomplete segments based on relative completed task segments.

12. The method of claim 1, wherein tracking resource contribution comprises one of using communication protocols or using completed task segments.

13. The method of claim 1, wherein credit categories comprise one or more of a multimedia category; a user category; a donation category; an application category; and a resources wholesale category.

14. The method of claim 1, wherein crediting an account comprises one or more of providing free resource availability; providing proportional resource availability; providing free or discounted movie tickets; providing points for online purchase credit; providing tax write-offs; and providing application access.

15. The method of claim 1, wherein the contributed resources a separate electronic device of a plurality of separate electronic devices comprise one or more of a set of processors, a set of memories, and a set of communication types.

16. A non-transitory computer-readable medium storing program code for marketing and selling contributed resources of a plurality of separate electronic devices that is executable by a computer to cause operations, comprising:
generating a framework for resource contribution, wherein assigned contributed resources are the contributed resources that are assigned to credit categories;
optimizing a credit category model based the assigned contributed resources using a dynamic availability of the assigned contributed resources and a processing requirement of a task;
tracking resource contribution using communication protocols based on completed task segments, wherein completed task segments are distributed task segments derived from the task that have been processed by the assigned contributed resources; and
crediting an account based on the tracked resource contribution.

17. An apparatus for marketing and selling contributed resources of a plurality of separate electronic devices, comprising:
a means to generate a framework for resource contribution, wherein assigned contributed resources are the contributed resources that are assigned to credit categories;
a means to optimize a credit category model based the assigned contributed resources using a dynamic availability of the assigned contributed resources and a processing requirement of a task;
a means to track resource contribution using communication protocols based on completed task segments, wherein completed task segments are distributed task segments derived from the task that have been processed by the assigned contributed resources; and
a means to credit an account based on the tracked resource contribution.
